(19) United States
(12) Patent Application Publication
(10) Pub. No.: US 2012/0137471 A1
(43) Pub. Date: Jun. 7, 2012

(54) Hinge Apparatus and Method

(75) Inventor: Pertti Kalevi KUJALA, Martinniemi (FI)

(73) Assignee: NOKIA CORPORATION, Espoo (FI)

(21) Appl. No.: 12/959,644

(22) Filed: Dec. 3, 2010

(51) Int. Cl. E05D 7/00; B21D 53/40

(52) U.S. Cl. 16/382; 29/11

(57) ABSTRACT

In accordance with an example embodiment, an apparatus comprises a hinge linkage member having first and second sides opposite each other and first and second shaped openings on at least one of the first and second sides; a first hinge bracket having a first axle element rotatably coupled with the hinge linkage member and movable with respect to a second axle element of a second hinge bracket, the first axle element extending at least partially through the first shaped opening; a second hinge bracket having the second axle element rotatably coupled with the hinge linkage member and movable with respect to the first axle element, the second axle element extending at least partially through the second shaped opening; and a latch rotatably coupled with the hinge linkage member, the latch being capable of securing the first hinge bracket when the second hinge bracket rotates to a open configuration.

### TECHNICAL FIELD

The present application relates generally to a hinge apparatus and method for a device.

### BACKGROUND

Electronic devices such as a laptop computer, a personal digital assistant (PDA), or a mobile phone may generally comprise two portions, a top housing and bottom housing, which are coupled with one or more hinges. One or more conventional hinges may be used to rotatably couple the top and bottom housings of the electronic device. Electronic devices with top and bottom housings connected by one or more conventional hinges may have a closed configuration and an open configuration.

### SUMMARY

Various aspects of examples of the invention are set out in the claims.

According to a first aspect of the present invention, an apparatus comprises a hinge linkage member having first and second sides opposite each other and first and second shaped openings on at least one of the first and second sides; a first hinge bracket having a first axle element rotatably coupled with the hinge linkage member and movable with respect to a second axle element of a second hinge bracket, the first axle element extending at least partially through the first shaped opening; a second hinge bracket having the second axle element rotatably coupled with the hinge linkage member and movable with respect to the first axle element, the second axle element extending at least partially through the second shaped opening; and a latch rotatably coupled with the hinge linkage member, the latch being capable of securing the first hinge bracket when the second hinge bracket rotates to a open configuration.

According to a second aspect of the present invention, an apparatus comprises a hinge linkage member having first and second sides opposite each other and first and second shaped openings on at least one of the first and second sides; a first hinge bracket having a first axle element rotatably coupled with the hinge linkage member and movable with respect to a second axle element of a second hinge bracket, the first axle element extending at least partially through the first shaped opening; a second hinge bracket having the second axle element rotatably coupled with the hinge linkage member and movable with respect to the first axle element, the second axle element extending at least partially through the second shaped opening; and a latch rotatably coupled with the hinge linkage member, the latch being capable of securing the second hinge bracket when the first hinge bracket rotates to a closed configuration.

According to a third aspect of the present invention, a method comprises releasing a first hinge bracket by rotating a second hinge bracket to a closed configuration, the releasing caused by a hinge axle element interfacing with a latch when the second hinge bracket rotates to a closed configuration.

### BRIEF DESCRIPTION OF THE DRAWINGS

For a more complete understanding of example embodiments of the present invention, reference is now made to the following descriptions taken in connection with the accompanying drawings in which:

FIG. 1 is a diagram of a device with an apparatus shown in a closed configuration according to an example embodiment of the invention;

FIG. 2 is a diagram of the device of FIG. 1 with a first and second apparatus shown in an open configuration according to an example embodiment of the invention;

FIG. 3 is a diagram of the device of FIG. 1 shown in an open configuration including two displays according to an example embodiment of the invention;

FIG. 4a is a diagram of an exploded view of an apparatus comprising at least one hinge bracket according to an example embodiment of the invention;

FIG. 4b is a diagram of an exploded view of an apparatus comprising at least one hinge bracket with a cam pin according to an example embodiment of the invention;

FIG. 5 is a diagram of an isometric view of an apparatus according to an example embodiment of the invention;

FIG. 6a is a diagram of a cross sectional view of an apparatus comprising at least one hinge bracket according to an example embodiment of the invention;

FIG. 6b is a diagram of a cross sectional view of an apparatus showing two cam pins according to an example embodiment of the invention;

FIG. 7a is a diagram of a cross sectional view of an apparatus of FIG. 6a showing an opposite side of the apparatus according to an example embodiment of the invention;

FIG. 7b is a diagram of a cross sectional view of an apparatus of FIG. 6b showing an opposite side of the apparatus according to an example embodiment of the invention;

FIG. 8a is a diagram of a cross sectional view of an apparatus in an open configuration having a latch securing a hinge bracket according to an example embodiment of the invention;

FIG. 8b is a diagram of a cross sectional view of an apparatus in an open configuration having a latch with hinge brackets unsecured according to an example embodiment of the invention;

FIG. 8c is a diagram of a cross sectional view of the apparatus of FIG. 8a in a partially open configuration having a latch with hinge brackets unsecured according to an example embodiment of the invention;

FIG. 8d is a diagram of a cross sectional view of the apparatus of FIG. 8b in an partially open configuration having a latch with hinge brackets unsecured according to an example embodiment of the invention;

FIG. 8e is a diagram of a cross sectional view of the apparatus of FIG. 8a in a closed configuration having a latch with hinge brackets unsecured according to an example embodiment of the invention;

FIG. 8f is a diagram of a cross sectional view of the apparatus of FIG. 8b in a closed configuration having a latch securing a hinge bracket according to an example embodiment of the invention; and

FIG. 9 is a flow diagram illustrating a method according to an example embodiment of the invention.

### DETAILED DESCRIPTION OF THE DRAWINGS

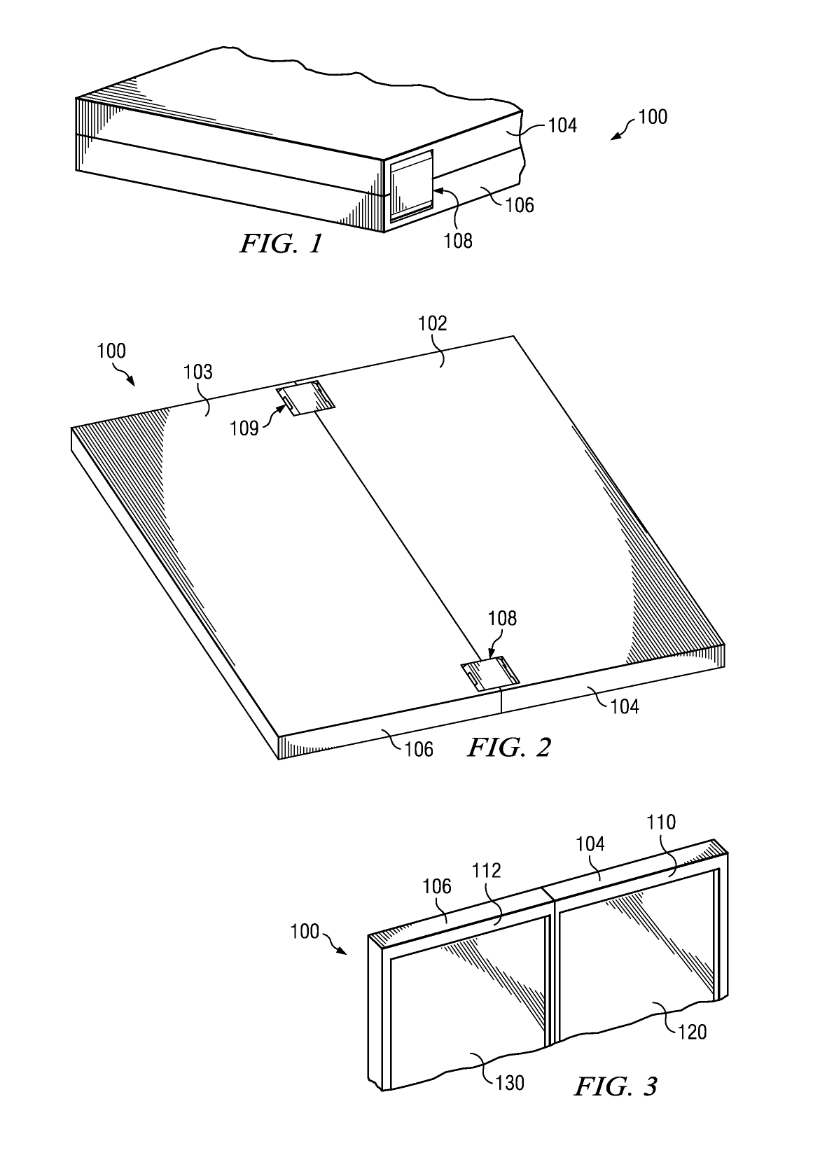

Example embodiments of the present invention and potential advantages are understood by referring to FIGS. 1 through 9 of the drawings.

FIG. 1 is a diagram of a device 100 with an apparatus 108 shown in a closed configuration according to an example embodiment of the invention. Device 100 may be any type of device including but not limited to an electronic device, mobile device, communication device, media player, camera, personal digital assistant and/or the like. In an embodiment, device 100 comprises a device member 104, a device member 106 and at least one apparatus such as apparatus 108.

In an embodiment, apparatus 108 is a hinge capable of enabling device 100 to enter an open configuration. In an embodiment, apparatus 108 allows the device member 104 and the device member 106 to pivot with respect to each other about at least one axis to enable device 100 to enter an open configuration such as the open configuration of device 100 depicted in FIG. 2. Further, in an embodiment, apparatus 108 allows the device member 104 and the device member 106 to pivot with respect to each other about at least one axis enabling device 100 to enter a closed configuration such as the closed configuration of device 100 depicted in FIG. 1.

In an embodiment, apparatus 108 is embedded within at least one of device member 104 and device member 106. In an embodiment, apparatus 108 embedded within device 100 is exposed and visible to a user as depicted in FIG. 1. In another embodiment, apparatus 108 embedded within device 100 is neither exposed nor visible to a user.

FIG. 2 is a diagram of device 100 of FIG. 1 with an apparatus 108 and an apparatus 109 shown in an open configuration according to an example embodiment of the invention. In an embodiment, device 100 has a device member 104 having a side 102 and side 110 as shown in FIG. 3. Further, in an embodiment, device 100 has a device member 106 having a side 103 and side 112 as shown in FIG. 3

FIG. 3 is a diagram of device 100 of FIG. 1 shown in an open configuration including a display 120 and a display 130 according to an example embodiment of the invention. In an embodiment, device member 104 comprises a display on side 110 such as display 120. Further, in an embodiment, device member 106 comprises a display on side 112 such as display 130. In an embodiment, the displays 120 and 130 of device 100 are substantially in parallel planes when device 100 is in a closed configuration. In an embodiment, displays 120 and 130 of device 100 are substantially within a single plane when device 100 is in an open configuration.

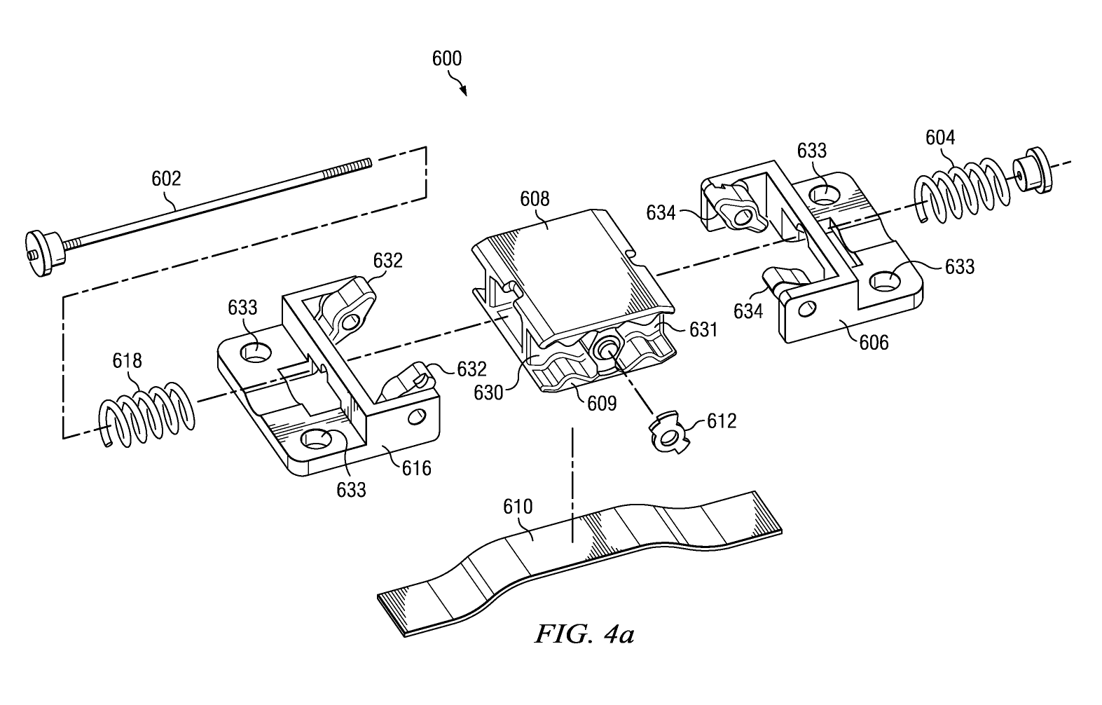

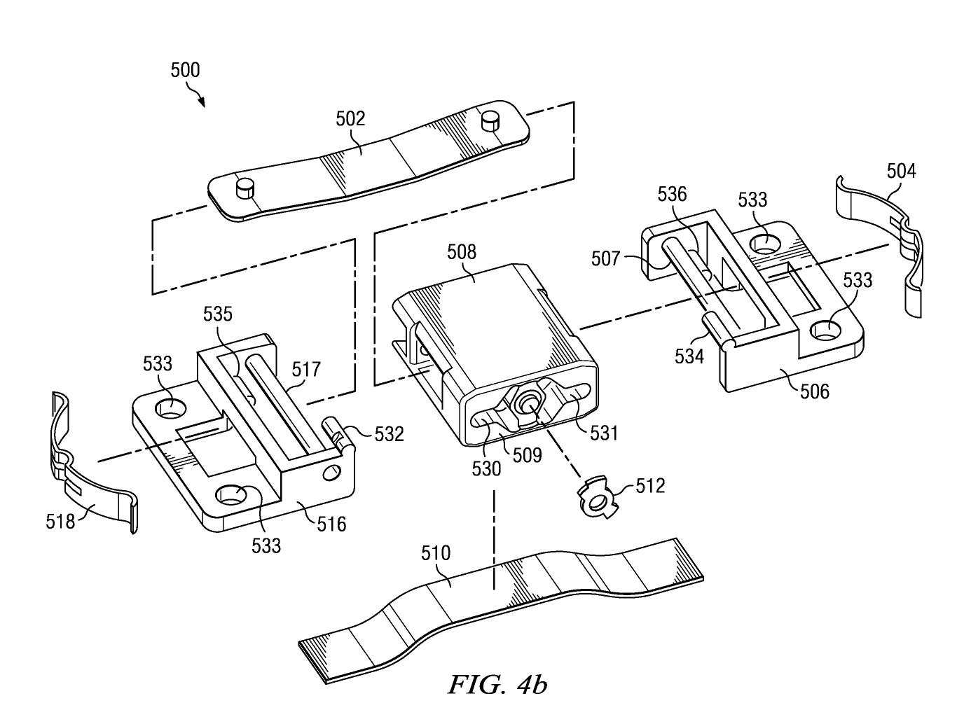

FIG. 4a is a diagram of an exploded view of an apparatus 600 comprising at least one hinge bracket according to an example embodiment of the invention. In an embodiment, apparatus 600 comprises a hinge linkage member 608 having a side 609. In an embodiment, the hinge linkage member 608 comprises a shaped opening 630 and a shaped opening 631 on at least one side.

In an embodiment, the apparatus 600 further comprises a hinge bracket 616 having at least one hinge axle element 632 rotatably coupled with the hinge linkage member 608 and movable with respect to at least one hinge axle element 634. In an embodiment, the hinge axle element 632 extends at least partially through the shaped opening 630.

In an embodiment, the apparatus 600 further comprises a hinge bracket 606 having at least one hinge axle element 634 rotatably coupled with the hinge linkage member 608 and movable with respect to the at least one hinge axle element 632. In an embodiment, the at least one hinge axle element 634 extends at least partially through the shaped opening 631 and interfaces with an interior surface of the hinge linkage member 608. In an embodiment, the apparatus 600 further comprises a latch 612 rotatably coupled with the hinge linkage member 608.

In an embodiment, hinge bracket 616 is coupled with a device member such as device member 104 of FIG. 1. In an embodiment, hinge bracket 606 is coupled with a device member such as device member 106 of FIG. 1. A hinge bracket may be coupled with a device member using any method such as but not limited to a fastener, adhesive and/or the like. Further, in an embodiment, holes such as holes 633 in each hinge bracket are used by a fastener to couple a device member to a hinge bracket.

In an embodiment, apparatus 600 further comprises a resilient member such as spring 602. Further, in an embodiment, apparatus 600 comprises a flexable circuit board such as flexable circuit board 610.

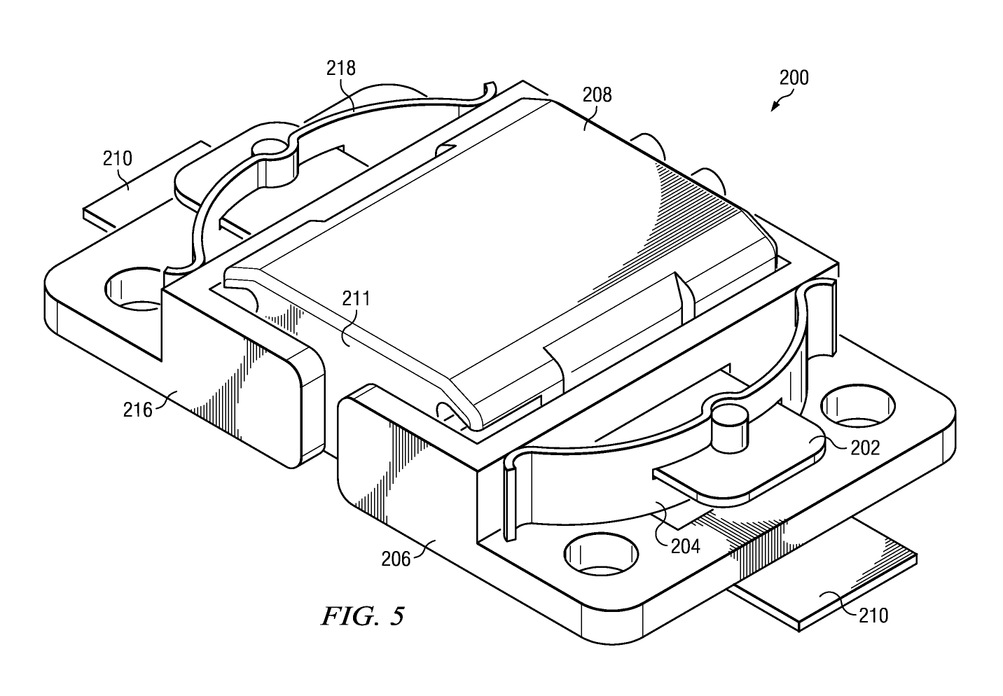

FIG. 4b is a diagram of an exploded view of an apparatus 500 comprising at least one hinge bracket with a cam pin according to an example embodiment of the invention. In an embodiment, apparatus 500 comprises a hinge linkage member 508 having a side 509 and an opposite side such as side 211 as depicted in FIG. 5. In an embodiment, the apparatus 500 further comprises shaped opening 530 and shaped opening 531 on at least one of sides 509 and 211.

In the embodiment, the apparatus 500 further comprises a hinge bracket 516 having a hinge axle element 517 rotatably coupled with the hinge linkage member 508 and movable with respect to hinge axle element 507. In an embodiment, the hinge axle element 517 extends at least partially through the shaped opening 530. In an embodiment, the hinge bracket 516 has a cam pin 532, which extends at least partially through the shaped opening 530 and interfaces with an interior surface of the hinge linkage member 508. In an embodiment, the hinge bracket 516 has a guide pin 535 which extends at least partially through an opening in the hinge linkage member 508 and interfaces with an interior surface of the hinge linkage member 508.

In an embodiment, the apparatus 500 further comprises a hinge bracket 506 having a hinge axle element 507 rotatably coupled with the hinge linkage member 508 and movable with respect to the hinge axle element 517. In an embodiment, the hinge axle element 507 extends at least partially through the shaped opening 531 and interfaces with an interior surface of the hinge linkage member 508. In the embodiment, the hinge bracket 506 has a cam pin 534, which extends at least partially through the shaped opening 531 and interfaces with an interior surface of the hinge linkage member 508. In the embodiment, the hinge bracket 506 has a guide pin 536, which extends at least partially through an opening in the hinge linkage member 508 and interfaces with an interior surface of the hinge linkage member 508. In an embodiment, the apparatus 500 further comprises a latch 512 rotatably coupled with the hinge linkage member 508.

In an embodiment, hinge bracket 516 is coupled with a device member such as device member 104 of FIG. 1. In an embodiment, hinge bracket 506 is coupled with a device member such as device member 106 of FIG. 1. A hinge bracket may be coupled with a device member using any method such as but not limited to a fastener, adhesive and/or the like. Further, in an embodiment, holes such as holes 533 in each hinge bracket are used by a fastener to couple a device member to a hinge bracket.

In an embodiment, apparatus 500 further comprises a resilient member such as spring 502. Further, in an embodiment, apparatus 500 further comprises a flexible circuit board such as flexible circuit board 510.

FIG. 5 is a diagram of an isometric view of apparatus 200 according to an example embodiment of the invention. In an embodiment, apparatus 200 comprises at least one hinge resilient member such as hinge springs 204 and 218. In an embodiment, hinge springs 204 and 208 are each coupled with at least one hinge bracket and at least one device member such as hinge brackets 206 and 216 and device members 104 and 106 of FIG. 1. In an embodiment, a hinge spring reduces mechanical stress and/or shock between a hinge bracket and a device member such as when a device member coupled with a hinge bracket rotates with respect to another device member coupled with another hinge bracket.

In an embodiment, apparatus 200 further comprises an extension cord such as extension cord 202. In an embodiment, an extension cord is used to bridge circuit pathways between two device members such as device member 104 and device member 106 both of FIG. 1. In an embodiment, extension cord 202 is bendable and/or elastic. In an embodiment, extension cord 202 extends at least partially through hinge linkage member 208 and is secured by hinge springs 204 and 218

In an embodiment, apparatus 200 further comprises a flexible circuit board such as flexible circuit board 210. In an embodiment, a flexible circuit board is used to bridge circuit pathways between two device members such as device member 104 and device member 106 both of FIG. 1. In an embodiment, flexible circuit board 210 extends at least partially through hinge linkage member 208 as shown.

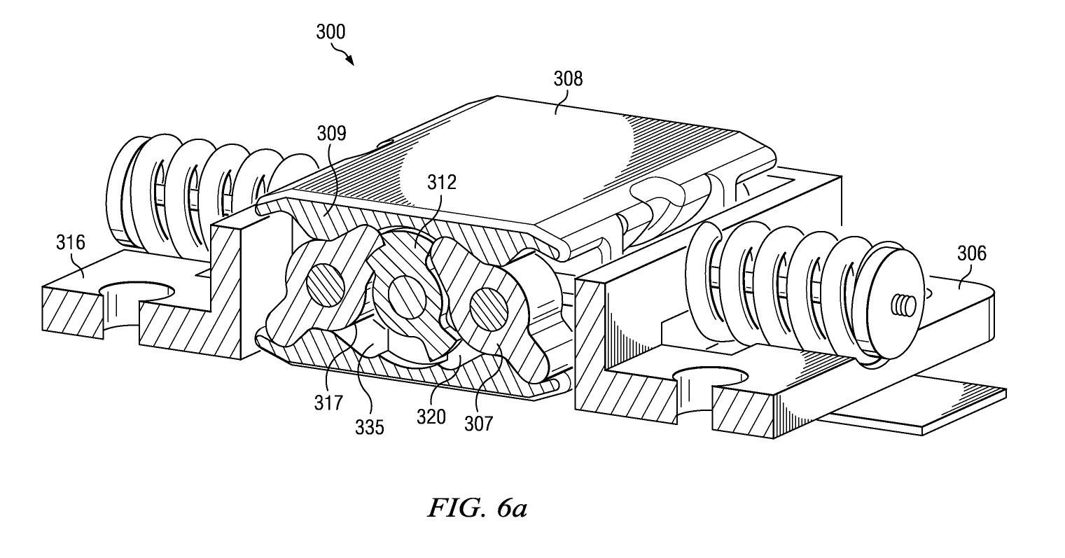

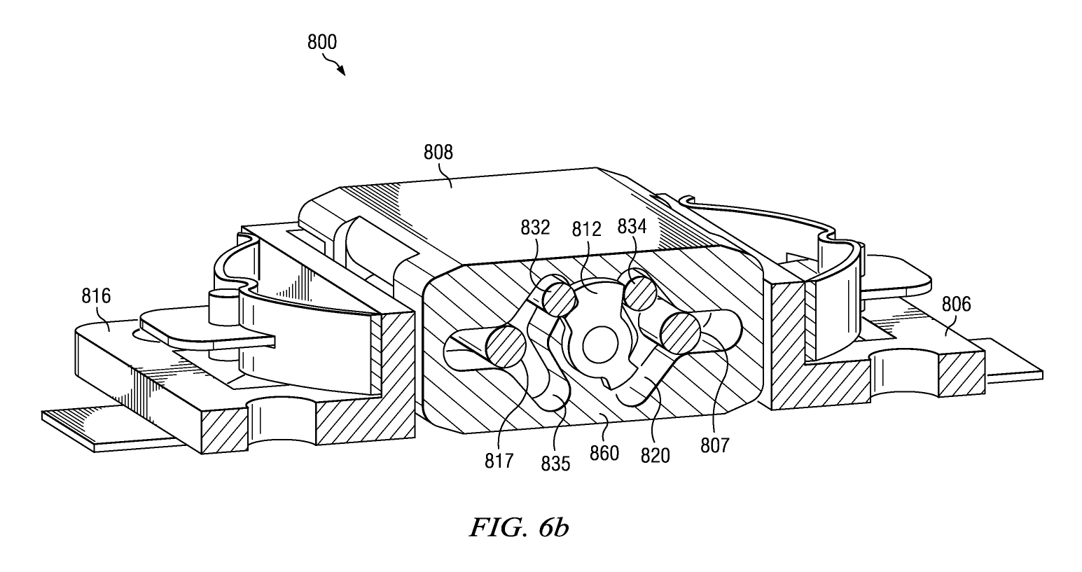

FIG. 6a is a diagram of a cross sectional view of apparatus 300 comprising at least one hinge bracket according to an example embodiment of the invention. In an embodiment, apparatus 300 comprises a hinge linkage member 308. In the embodiment, hinge linkage member 308 comprises a shaped opening 335 and a shaped opening 320 on at least one side. In the embodiment, the apparatus 300 further comprises a hinge bracket 316 having a hinge axle element 317 rotatably coupled with the hinge linkage member 308 and movable with respect to a hinge axle element 307. In the embodiment, the hinge axle element 317 extends at least partially through the shaped opening 335.

In an embodiment, the apparatus 300 further comprises a hinge bracket 306 having a hinge axle element 307 rotatably coupled with the hinge linkage member 308 and movable with respect to the hinge axle element 317. In an embodiment, the hinge axle element 307 extends at least partially through the shaped opening 320 and interfaces with an interior surface of the hinge linkage member 308.

In an embodiment, the apparatus 600 further comprises a latch 312 rotatably coupled with the hinge linkage member 308. In an embodiment, the latch 312 is capable of rotating with respect to the hinge linkage member 308.

In an embodiment, latch 312 is capable of securing hinge axle element 317 and hinge bracket 316 when hinge bracket 306 rotates to an open configuration such as the open configuration of FIG. 6a. In an embodiment, latch 312 is capable of releasing hinge axle element 317 and hinge bracket 316 when hinge bracket 306 rotates to a closed configuration such as the closed configuration of FIG. 1. In an embodiment, the securing and/or releasing is caused by the hinge bracket 316 interfacing with latch 312.

In an embodiment, latch 312 is capable of securing hinge axle element 307 and hinge bracket 306 when hinge bracket 316 rotates to a closed position. In an embodiment latch 312 is capable of releasing hinge axle element 307 and hinge bracket 306 when hinge bracket 316 rotates to an open configuration. In an embodiment, the securing and/or releasing is caused by the hinge bracket 316 interfacing with latch 312.

In an embodiment, apparatus 300 is apparatus 600 of FIG. 4a. In an embodiment, apparatus 300 is apparatus 100 of FIG. 1.

FIG. 6b is a diagram of a cross sectional view of apparatus 800 showing a cam pin 832 and a cam pin 834 according to an example embodiment of the invention. In an embodiment, apparatus 800 comprises a hinge linkage member 808. In the embodiment, the hinge linkage member 808 comprises a shaped opening 835 and a shaped opening 820. In the embodiment, the apparatus 800 further comprises a hinge bracket 816 having a hinge axle element 817 rotatably coupled with the hinge linkage member 808 and movable with respect to a hinge axle element 807. In the embodiment, the hinge axle element 817 extends at least partially through the shaped opening 835. In the embodiment, the hinge bracket 816 has a cam pin 832 which extends at least partially through the shaped opening 835 and interfaces with an interior surface of the hinge linkage member 808.

In an embodiment, the apparatus 800 further comprises a hinge bracket 806 having a hinge axle element 807 rotatably coupled with the hinge linkage member 808 and movable with respect to the hinge axle element 817. In an embodiment, the hinge axle element 807 extends at least partially through the shaped opening 820 and interfaces with an interior surface of the hinge linkage member 808. In the embodiment, the hinge bracket 806 has a cam pin 834 which extends at least partially through the shaped opening 820 and interfaces with an interior surface of the hinge linkage member 808. In an embodiment, apparatus 800 is apparatus 500 of FIG. 4b. In an embodiment, apparatus 800 is apparatus 100 of FIG. 1.

In an embodiment, the apparatus 600 further comprises a latch 812 rotatably coupled with the hinge linkage member 808. In an embodiment, the latch 812 is capable of rotating with respect to the hinge linkage member 808.

In an embodiment, latch 812 is capable of securing hinge axle element 817 and hinge bracket 816 when hinge bracket 806 rotates to an open configuration such as the open configuration of FIG. 6b. In an embodiment, latch 812 is capable of releasing hinge axle element 817 and hinge bracket 816 when hinge bracket 806 rotates to a closed configuration such as the closed configuration of FIG. 1. In an embodiment, the securing and/or releasing is caused by the hinge bracket 816 interfacing with latch 812.

In an embodiment, latch 812 is capable of securing hinge axle element 807 and hinge bracket 806 when hinge bracket 816 rotates to a closed position. In an embodiment latch 812 is capable of releasing hinge axle element 807 and hinge bracket 806 when hinge bracket 816 rotates to an open configuration. In an embodiment, the securing and/or releasing is caused by the hinge bracket 816 interfacing with latch 812.

In an embodiment, apparatus 800 is apparatus 600 of FIG. 4b. In an embodiment, apparatus 800 is apparatus 100 of FIG. 1.

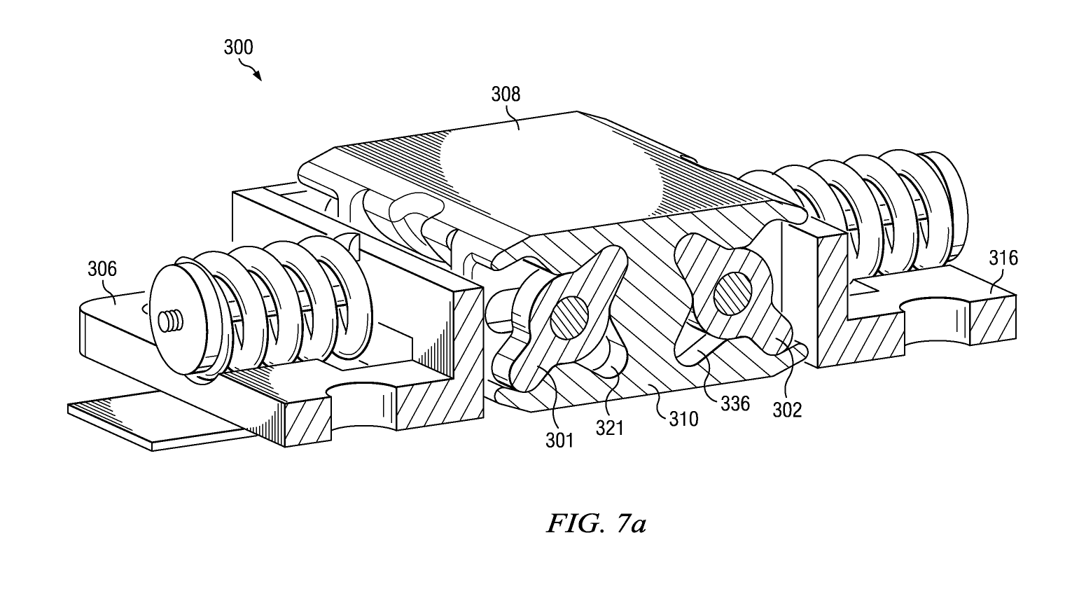

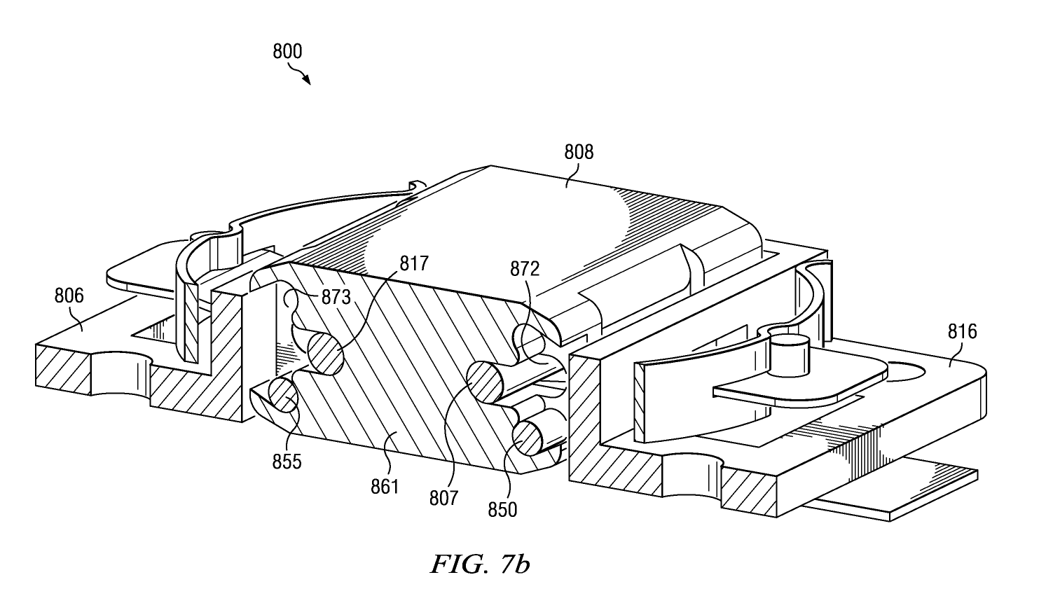

FIG. 7a is a diagram of a cross sectional view of apparatus 300 of FIG. 6a showing an opposite side 310 of apparatus 300 according to an example embodiment of the invention. In an embodiment, the apparatus 300 further comprises hinge bracket 316 having a hinge axle element 302 rotatably coupled with the hinge linkage member 308 and movable with respect to a hinge axle element 301. In the embodiment, the hinge axle element 302 extends at least partially through the shaped opening 336.

In an embodiment, the apparatus 300 further comprises hinge bracket 306 having a hinge axle element 301 rotatably coupled with the hinge linkage member 308 and movable with respect to a hinge axle element 302. In the embodiment, the hinge axle element 301 extends at least partially through the shaped opening 321.

FIG. 7b is a diagram of a cross sectional view of an apparatus 808 of FIG. 6b showing an opposite side 861 of apparatus 800 according to an example embodiment of the invention. In an embodiment, hinge bracket 806 comprises hinge axle element 817 and guide pin 855. In the embodiment, the apparatus 800 further comprises a shaped opening 873. In the embodiment, the hinge axle element 817 extends at least partially through the shaped opening 873. In an embodiment, guide pin 855 extends at least partially through the shaped opening 873 and interfaces with an interior surface of the hinge linkage member 808.

In an embodiment, hinge bracket 816 comprises hinge axle element 807 and guide pin 850. In the embodiment, the apparatus 800 further comprises a shaped opening 872. In the embodiment, the hinge axle element 807 extends at least partially through shaped opening 872. Guide pin 850 extends at least partially through the shaped opening 872 and interfaces with an interior surface of the hinge linkage member 808.

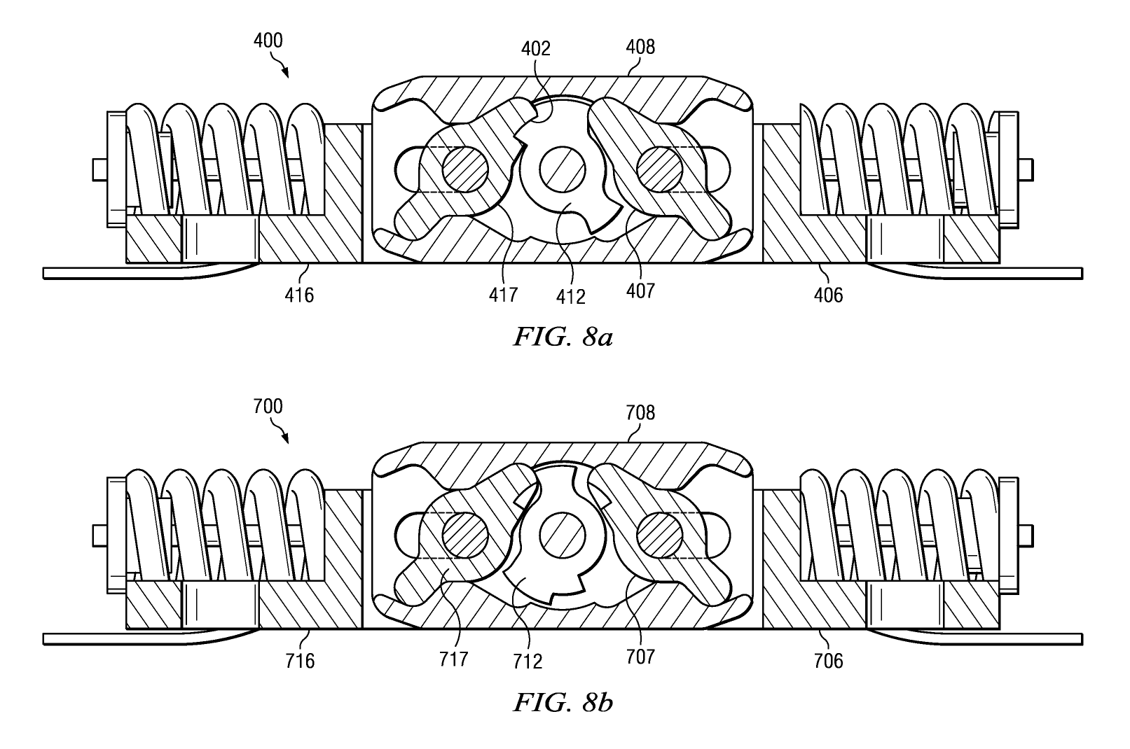

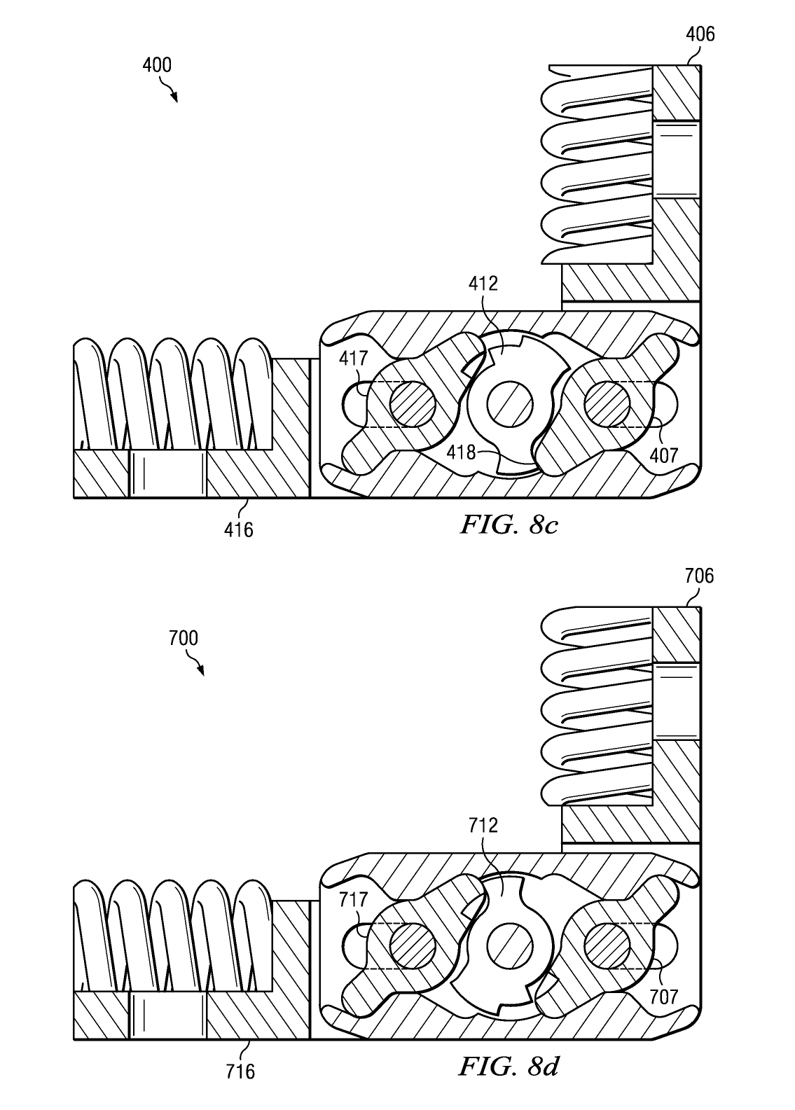

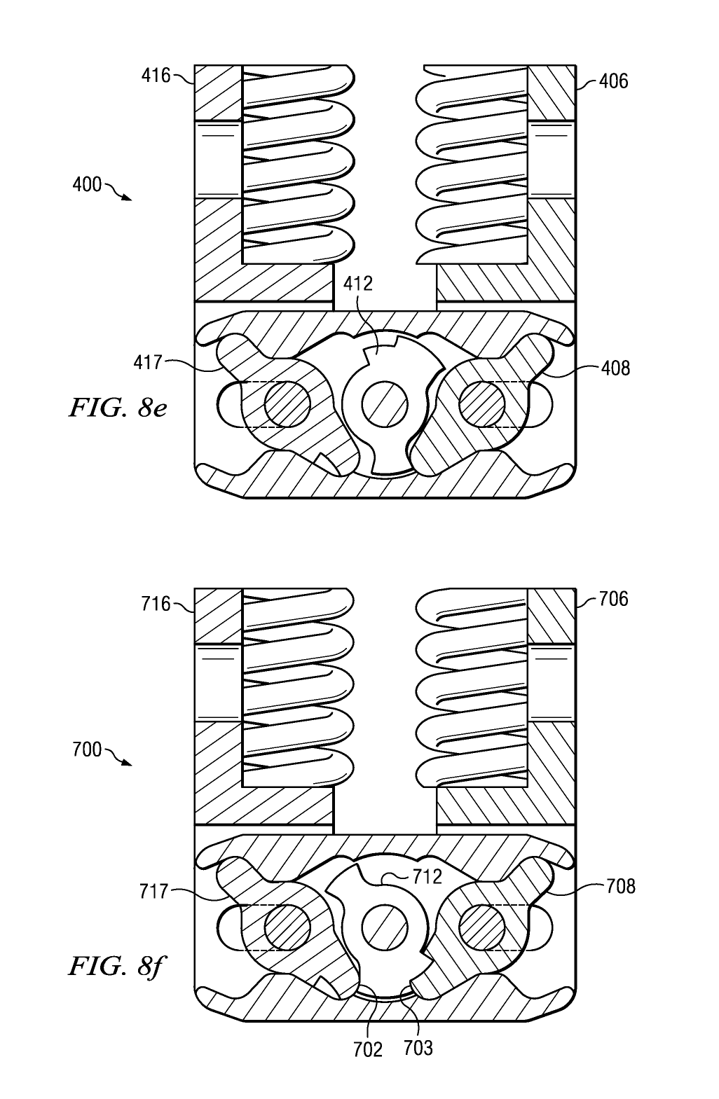

FIG. 8a is a diagram of a cross sectional view of an apparatus 400 in an open configuration having a latch 412 securing hinge bracket 416 according to an example embodiment of the invention. In an embodiment, apparatus 400 is apparatus 109 of FIG. 2. In an embodiment, the apparatus 400 comprises latch 412 rotatably coupled with the hinge linkage member 408. In an embodiment, the latch 412 is capable of rotating with respect to the hinge linkage member 408. In an embodiment, latch 412 secures hinge axel element 417, which prevents hinge bracket 416 from rotating. However, in the embodiment, hinge axle element 407 and hinge bracket 406 are not secured. In an embodiment, apparatus 400 is apparatus 600 of FIG. 4a. In an embodiment, apparatus 400 is apparatus 300 of FIG. 6a.

FIG. 8b is a diagram of a cross sectional view of an apparatus 700 in an open configuration having a latch 712 with hinge brackets 716 and 706 both unsecured according to an example embodiment of the invention. In an embodiment, apparatus 700 is apparatus 108 of FIG. 2. In an embodiment, the apparatus 700 comprises latch 712 rotatably coupled with the hinge linkage member 708. In the embodiment, the latch 712 is capable of rotating with respect to the hinge linkage member 708. In the embodiment, latch 712 does not secure hinge axel element 717 and hinge bracket 716 is capable of rotating. Further, in the embodiment, hinge axle element 707 is not secured by latch 712 and hinge bracket 706 is capable of rotation. In an embodiment, apparatus 700 is apparatus 600 of FIG. 4a. In an embodiment, apparatus 700 is apparatus 300 of FIG. 6a.

FIG. 8c is a diagram of a cross sectional view of the apparatus 400 of FIG. 8a in a partially open configuration having a latch 412 with hinge brackets 416 and 406 unsecured according to an example embodiment of the invention. In an embodiment, apparatus 400 is apparatus 109 of FIG. 2. In the embodiment, hinge bracket 406 has been rotated 90 degrees as shown. In the embodiment, when hinge bracket 406 is rotated, hinge axle element 407 interfaces with latch 712 at location 418 releasing hinge axle element 417, which releases hinge bracket 416. In the embodiment, at this point, hinge bracket is capable of rotating due to the releasing.

FIG. 8d is a diagram of a cross sectional view of the apparatus 700 of FIG. 8b in a partially open configuration having a latch 712 with hinge brackets 716 and 706 unsecured according to an example embodiment of the invention. In the embodiment, hinge bracket 706 has been rotated 90 degrees as shown. In the embodiment, when hinge bracket 406 is rotated, latch 712 does not affect hinge axle elements 717 and 707. In the embodiment, both hinge axle elements 717 and 707 are capable of rotating. In an embodiment, apparatus 700 is apparatus 108 of FIG. 2.

FIG. 8e is a diagram of a cross sectional view of the apparatus 400 of FIG. 8a in a closed configuration having a latch 412 with hinge brackets unsecured according to an example embodiment of the invention. In the embodiment, when hinge bracket 416 is rotated 90 degrees from the configuration of FIG. 8c to the closed configuration of FIG. 8e, latch 712 does not affect hinge axle elements 417 nor 407. In the embodiment, both hinge axle elements 417 and 407 are unsecured by latch 412 and capable of rotating. In an embodiment, apparatus 400 is apparatus 109 of FIG. 2.

FIG. 8f is a diagram of a cross sectional view of the apparatus 700 of FIG. 8b in a closed configuration having a latch 712 securing a hinge bracket 717 according to an example embodiment of the invention. In an embodiment, apparatus 700 is apparatus 108 of FIG. 2. In an embodiment, hinge bracket 716 has been rotated 90 degrees as shown from the configuration in FIG. 8c. In the embodiment, when hinge bracket 716 is rotated, hinge axle element 717 interfaces with latch 712 at location 702, wherein latch 712 interfaces with hinge axle element 708 securing hinge axle element 708. In the embodiment, securing hinge axle element 708 prevents hinge bracket 706 from rotating. In an embodiment, apparatus 700 is apparatus 108 of FIG. 2.

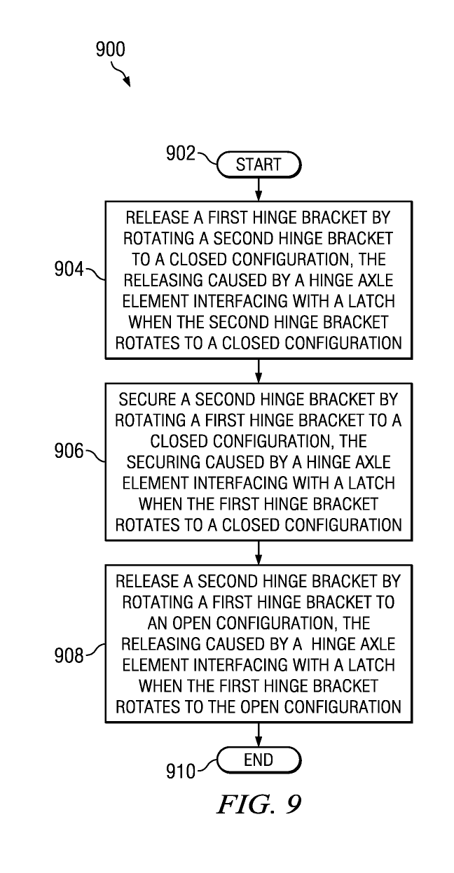

FIG. 9 is a flow diagram illustrating a method 900 according to an example embodiment of the invention. In an embodiment, the method begins at 902. In an embodiment, at 904, a first hinge bracket such as hinge bracket 416 of FIG. 8c is released by rotating a second hinge bracket such as hinge bracket 406 to a closed configuration such as the closed configuration of hinge bracket 406 as depicted in FIG. 8c. In an embodiment, the first hinge bracket is released by a latch such as latch 412 of FIG. 8c unsecuring a hinge axle element such as hinge axle element 417. In the embodiment, when a second hinge bracket is rotated such as hinge bracket 406 to a closed configuration, a hinge axle element such as hinge axle element 407 interfaces with a latch such as latch 412 to cause the releasing.

In an embodiment, at 906, a second hinge bracket is secured such as hinge bracket 706 in FIG. 8f by rotating a first hinge bracket such as hinge bracket 716 of FIG. 8f to a closed configuration. In an embodiment, the second hinge bracket is secured by a latch such as latch 712 of FIG. 8f when a hinge axle element such as hinge axle element 717 interfaces with the latch.

In an embodiment, at 908, a second hinge bracket is released such as hinge bracket 706 in FIG. 8b by rotating a first hinge bracket such as hinge bracket 716 to an opening configuration. In an embodiment, the releasing is cause by a hinge axle element such as hinge axle element 717 of FIG. 8f interfacing with a latch such as latch 712. The method ends at 910.

Without in any way limiting the scope, interpretation, or application of the claims appearing below, a technical effect of one or more of the example embodiments disclosed herein is release a first hinge bracket by rotating a second hinge bracket to a closed position. Another technical effect of one or more of the example embodiments disclosed herein is securing a second hinge bracket by rotating a first hinge bracket to a closed configuration. Another technical effect of one or more of the example embodiments disclosed herein is releasing a second hinge bracket by rotating a first hinge bracket to an open configuration.

If desired, the different methods discussed herein may be performed in a different order and/or concurrently with each other. Furthermore, if desired, one or more of the above-described methods may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a hinge linkage member having first and second sides opposite each other and first and second shaped openings on at least one of said first and second sides;
a first hinge bracket having a first axle element rotatably coupled with said hinge linkage member and movable with respect to a second axle element of a second hinge bracket, said first axle element extending at least partially through said first shaped opening;
a second hinge bracket having said second axle element rotatably coupled with said hinge linkage member and movable with respect to said first axle element, said second axle element extending at least partially through said second shaped opening; and
a latch rotatably coupled with said hinge linkage member, said latch being capable of securing said first hinge bracket when said second hinge bracket rotates to a open configuration.

2. An apparatus according to claim 1, wherein said first hinge bracket further comprises a cam pin, said cam pin extending at least partially through said first shaped opening and interfacing with an interior surface of said hinge linkage member.

3. An apparatus according to claim 1, wherein said second hinge bracket further comprises a cam pin, said cam pin extending at least partially through said second shaped opening and interfacing with an interior surface of said hinge linkage member.

4. An apparatus according to claim 1, wherein said latch is capable of releasing said first hinge bracket when said second hinge bracket rotates to a closed configuration.

5. An apparatus according to claim 1, wherein said second axle element interfaces with said latch to cause said securing.

6. An apparatus according to claim 1, wherein said second axle element moves with respect to said first axle element when said second hinge bracket rotates.

7. An apparatus according to claim 1, wherein said first hinge bracket is coupled with a first member and said second hinge bracket is coupled with a second member.

8. An apparatus according to claim 1, wherein said latch rotates with respect to said hinge linkage member when said second hinge bracket rotates.

9. An apparatus according to claim 1, further comprising a first guide pin coupled with said first hinge bracket, said first guide pin at least partially extending through an opening on a side of said hinge linkage member opposite to said first shaped opening, said first guide pin interfacing with an interior surface of said hinge linkage member.

10. An apparatus according to claim 1, further comprising a second guide pin coupled with said second hinge bracket, said second guide pin extending through an opening on a side of said hinge linkage member opposite to said second shaped opening, said second guide pin interfacing with an interior surface of said hinge linkage member.

11. An apparatus, comprising:
a hinge linkage member having first and second sides opposite each other and first and second shaped openings on at least one of said first and second sides;
a first hinge bracket having a first axle element rotatably coupled with said hinge linkage member and movable with respect to a second axle element of a second hinge bracket, said first axle element extending at least partially through said first shaped opening;
a second hinge bracket having said second axle element rotatably coupled with said hinge linkage member and movable with respect to said first axle element, said second axle element extending at least partially through said second shaped opening; and
a latch rotatably coupled with said hinge linkage member, said latch being capable of securing said second hinge bracket when said first hinge bracket rotates to a closed configuration.

12. An apparatus according to claim 11, wherein said first hinge bracket having a first cam pin extends at least partially through said first shaped opening and interfaces with an interior surface of said hinge linkage member.

13. An apparatus according to claim 11, wherein said second hinge bracket having a second cam pin extends at least partially through said second shaped opening and interfaces with an interior surface of said hinge linkage member.

14. An apparatus according to claim 11, wherein said latch is capable of releasing said second hinge bracket when said first hinge bracket rotates to an open configuration.

15. An apparatus according to claim 11, wherein said latch interfaces with said first axle element to cause said securing.

16. An apparatus according to claim 11, wherein said first axle element moves with respect to said second axle element when said first hinge bracket rotates to a closed configuration.

17. An apparatus according to claim 11, wherein said first hinge bracket is coupled with a first member and said second hinge bracket is coupled with a second member.

18. An apparatus according to claim 11, wherein said latch rotates with respect to said hinge linkage member when said first hinge bracket rotates to a closed configuration.

19. An apparatus according to claim 11, further comprising a guide pin coupled with said first hinge bracket, said guide pin extending through an opening on a side of said hinge linkage member opposite to said first shaped opening, said guide pin interfacing with an interior surface of said hinge linkage member.

20. An apparatus according to claim 11, further comprising a guide pin coupled with said second hinge bracket, said guide pin extending through an opening on a side of said hinge linkage member opposite to said second shaped opening, said guide pin interfacing with an interior surface of said hinge linkage member.

21. A method, comprising:
releasing a first hinge bracket by rotating a second hinge bracket to a closed configuration, said releasing caused by a hinge axle element interfacing with a latch when said second hinge bracket rotates to a closed configuration.

22. A method according to claim 21, further comprising:
securing said second hinge bracket by rotating said first hinge bracket to a closed configuration, said securing caused by a hinge axle element interfacing with said latch when said first hinge bracket rotates to said closed configuration.

23. A method according to claim 21, further comprising:
releasing said second hinge bracket by rotating said first hinge bracket to an open configuration, said releasing caused by a hinge axle element interfacing with said latch when said first hinge bracket rotates to said open configuration.
